(19) United States
(12) Patent Application Publication
(10) Pub. No.: US 2006/0166065 A1
(43) Pub. Date: Jul. 27, 2006

(54) Mini fuel battery with screw closure system

(75) Inventors: Igor Cantero Uribe-Echeberria, San Sebastian (ES); Francisco Javier Rodriguez Parra, San Sebastian (ES); Hans-Jurgen Grande Telleria, Ordizia (ES); Oscar Miguel Crespo, San Sebastian (ES)

Correspondence Address: LUCAS & MERCANTI, LLP, 475 PARK AVENUE SOUTH, 15TH FLOOR, NEW YORK, NY, 10016, US

(73) Assignee: Celaya Emparanza y Galdos, S.A. (Cegasa)

(21) Appl. No.: 11/185,509

(22) Filed: Jul. 20, 2005

(30) Foreign Application Priority Data
Aug. 2, 2004 (ES) 200401921

(51) Int. Cl. H01M 8/10; H01M 8/02

(52) U.S. Cl. 429/32; 429/35

(57) ABSTRACT

This mini fuel cell battery has a central body into which two membrane electrode assemblies are positioned, one at each end of the central body. An anodic space is defined between the two membrane assemblies. The central body has two internal threads into which two externally threaded rings are screwed in to seal the membrane assemblies in the central body.

### FIELD OF THE INVENTION

The object of the present invention is a mini fuel cell with a screw closure system which makes it possible to carry out perfect sealing of the fuel cell, and eliminates the use of other securing systems which are common in the prior state of the art, such as adhesives, nuts, screws and the like.

By means of the characteristics inherent in the design which is the subject of the present invention, it is possible to use construction materials which are conventional, light, economical and easy to mechanise, all with a reduced number of parts, and the design is thus easy to industrialise, unlike most designs proposed in the prior art.

Finally, this mini fuel cell has a design which can easily be adapted to the voltages and powers required for the final application, and it can easily be configured to operate with hydrogen, methanol or other fuels.

### PRIOR STATE OF THE ART

Fuel cells are being consolidated as a method for energy generation which can overcome some limitations and disadvantages of the conventional technologies, all for a wide range of applications. Most attention has conventionally been focussed on applications with the greatest strategic and economic implications, such as the field of transport and distributed generation. For the first of these, compared with the conventional technology, fuel cells have primarily the advantage of their potential independence from fossil fuels; secondarily there are their modularity and flexibility in adapting to different sizes and power levels, as well as a high level of energy efficiency, particularly if solutions of co-generation of electricity and residual heat are adopted. Against these advantages, at present there are some barriers which are delaying the emergence of these cells on the market, i.e. the high price of their essential components, their limited service life, and the problem of selection and distribution of the fuel.

In general, low-power portable applications are the third field of application concerned. Traditionally, less attention has been paid to this field, probably for reasons of lower economic and strategic relevance compared with the first two, i.e. transport and distributed generation. However, this trend is gradually beginning to change. There are two basic reasons for this: the first of these is the reduced relative importance in this field of application of limitations such as the high price of the components, or the relatively short life expectancy of the present systems. For example, a cost of 5000 ∉/kW and a service life of 1000 hours may be unacceptable for transport, but acceptable for an application in the niche of low power and high added value. The second reason is that the progressive introduction onto the market of fuel cells in low-power applications can be very useful for getting the consumer to know the technology, and for opening up distribution channels for the fuels, whether this is methanol, hydrogen or the like, with a view to determining the bases for future sale on a large scale.

There exist various specific fields of application within the context of low power, to which much attention is being paid. In the lowest power range, some of these applications are: direct supply, or cell chargers for consumer electronic equipment (mobile phones, digital notebooks and the like) with power of between 1 and 5 Watts, direct supply of portable computers (from 20 W upwards), supply of telecommunications systems (from approximately 10 W upwards), industrial signalling applications (from a few Watts upwards), the field of games, etc. In all these applications, the main advantage of fuel cell systems compared with conventional batteries is their greater capacity for energy storage per unit of weight and/or volume, as well as the instantaneous recharging of the fuel.

Polymer membrane fuel cells are the reference technology for all of this range of applications, basically because of their capacity for functioning at relatively low temperatures (from approximately 0° C. up to 80° C.) and because of their simplicity, which in some cases makes it possible to dispense with a large number of auxiliary subsystems which are essential in other types of fuel cells which complicate the system and make it more expensive.

From the technological point of view, most of the attention is paid to optimisation of the active components of the fuel cell, i.e. long-life electrolytic membranes, which have a low price and good conductivity, and are not affected by damp, electro-catalysts which are resistant to pollution by impurities or by-products, with little use of noble metals or none at all, electrodes with an optimum formulation and low content of electro-catalyst, etc. In addition, unlike fuel cells with a conventional polymer membrane (for power levels which in general are higher than 50 W), in the case of mini or micro fuel cells, no concept of a standardised structural design exists. Thus, there coexist numerous design proposals which attempt to obtain maximum compactness and density of power, and try to provide solutions to the problems of sealing and discharge of the by-products generated (heat and water vapour). In some cases, designs have been proposed which are extremely complex and intrinsically costly-to produce, using techniques of lithography on silicon wafers [CEA Grenoble], micro-mechanisation of ceramic materials including subsystems for recovery and recirculation of water [Motorola], or designs based on printed circuit base boards [Journal of Power Sources 118 (2003) 162-171], in addition to certain fuel cell designs with cylindrical, tubular or polygonal shapes [US2003/0186100 Al, US2003/0021890 Al, US 2003/0180600 Al].

In view of this situation, the opportunity exists to explore design concepts wherein precedence is given to structural simplicity and economy of materials rather than to technical complexity which is also at the cost of a certain loss of power density, all of this being with the objective of reducing the cost of the structural components of the mini fuel cell by means of the lack of complex manufacturing processes and the use of low-cost, high-performance structural materials.

### EXPLANATION OF THE INVENTION AND ADVANTAGES

The subject of the present invention is a passive mini fuel cell some of the characteristics of which are maximum modularity and flexibility, simplicity of design, and a reduced number of components, all using economic low-cost conventional materials which have a sufficient level of performance, and with a design which guarantees the sealing of the system against undesirable fuel leaks.

This mini fuel cell design can be used for functioning with hydrogen (obtained from reforming, hydrolysis, or chemical decomposition of hydrides), methanol in an aqueous solution, or other fuels, simply by replacing the electrode/electrolytic membrane/electrode assemblies or MEA (“Membrane Electrode Assembly” as it is most commonly known in English), if appropriate, by others which are more suitable for the fuel used. The mini fuel cell which is the subject of the invention can function with the fuel in static mode (or in dead-end mode, as it is habitually called in English), or in a continuous flow, according to the particular needs of each case.

The present invention relates to the fuel cell itself, and not to other auxiliary or associated systems such as the system for storage and metering of the fuel, the electronic part for conditioning of the current, or other elements which can optionally form part of the system as a whole. Nor does it relate specifically to the particular characteristics of the electrochemically active part of the fuel cell, i-e. the MEA (Membrane Electrode Assembly).

“Passive fuel cell” means a fuel cell which, in its simplest design, can function without auxiliary elements for control of the temperature or humidity in its interior, as well as without means for forced supply of fuel or oxidant.

The modularity and flexibility of the mini fuel cell which is the subject of the present invention relates to its versatility of design, which makes it possible to obtain an entire range of possibilities concerning the number of its elemental cells and electrode surface area (in general starting from approximately 1 cm²), which in turn makes it possible to construct systems with some nominal characteristics of voltage and current, by means of the particular application in question.

The mini fuel cell which is the subject of the invention is based on a contiguous flat arrangement of the elemental cells. There therefore exist two basic options for the configuration of the mini-fuel cell: in the preferred option the design is based on a said elemental module consisting of two unit cells which are disposed symmetrically on both sides of a common anodic compartment, through which the liquid or gaseous fuel is disposed, leaving the outer surface of both cells exposed to the air, which acts as a cathodic oxidant, as will be described in greater detail in subsequent paragraphs. The lateral interconnection of modules of this type will lead to the production of mini-fuel cells with an even number of unit cells on both surfaces of the system, thus optimising the use of the entire surface area available and leading to a relatively high specific power.

In the second option, which is of interest for devices in which it may be difficult for the oxygen in the air to gain access to one of the surfaces of the mini-fuel cell, for example in applications in which the fuel cell must rest supported on one of its surfaces, it is also possible to arrange the unit cells on a single side of the anodic compartment, leaving the other side blind. This option has the advantage that it can adapt more easily to certain specific applications, although in general it will lead to lower specific power levels than in the preferred option with cells on both surfaces.

In the spirit of the present patent for an invention, that option will therefore be considered as a special case which is apparent from the general option, in which the cells are disposed on both sides of the system, and the latter is the option which is described in the following paragraphs.

Each unit cell consists of an MEA (Membrane Electrode Assembly), which in turn is disposed between the two electronic collectors. The basic design of these collectors consists of a thin metal plate (less than 1 mm thick, and ideally between 0.1 and 0.5 mm) which permits the flow of electrons to the anodic electrode and from the cathodic electrode of the MEA (Membrane Electrode Assembly) respectively. These collectors must also have a series of perforations which permit access by the reagents and electrochemical reaction products to and from the electrodes. These reagents and products can be in a gaseous phase (e.g. hydrogen), a liquid phase (e.g. aqueous methanol), or a vapour phase, (water vapour). These collectors must be satisfactorily mechanically rigid, have a high level of surface electrical conductivity and contact, and sufficient chemical inertia in relation to corrosion. Some materials which are suitable for these collectors are stainless steel, optionally covered with a coating to protect against passivation, or nitrided titanium, for example. The electronic collectors must have a circular shape, which is highly advantageous since the electrode surfaces have the same circular shape, for the purpose of optimising the space available.

The two sets of collectors—MEAs—collectors are disposed on both sides of a hollow central body, thus delimiting the aforementioned anodic compartment. This central body must have one intake aperture, and generally another, output aperture for supply of the fuel to the anodic compartment and for circulation of the fuel, whether this is in liquid or gaseous form. One of the main characteristics of the invention is the method used for assembly of the sets of collectors—MEAs—collectors on the central body by means of a screwing procedure. Thus, each set of collector—MEA—collector is pressed around its perimeter by a ring with a screw on its outer perimeter (of a male type), which is screwed onto the central body (which in turn has a female screw thread for this purpose) until it abuts a bracket which in turn delimits the perimeter of the anodic compartment. The pressure which is exerted in succession by the ring on the cathodic collector, the MEA (Membrane Electrode Assembly), the anodic collector and the said bracket, makes it possible to obtain adequate sealing in the perimeter area and in the vicinity of the surface of the electrode. In order to optimise the sealing characteristics, especially in critical cases in which it is chosen to supply gaseous fuels at a certain excess pressure relative to the atmosphere, it is possible optionally to provide different means for guaranteeing the sealing further still, in order to prevent the risk of undesirable leakages. For example, it is possible to place a flat seal between the said bracket and the anodic collector, or an o-ring which is accommodated in a channel etched into the bracket. The design which is described in this patent makes it unnecessary to have any type of additional sealing element between the cathodic collector and the male ring. As an alternative to the screwing method, but based on a concept with a similar philosophy, it is possible to use a system of flanges with an inclined plane, of the type used to close the compartment for button batteries in small electronic devices.

Simplicity of design, which is one of the essential qualities of the present invention, involves the possibility of using economic structural materials for construction of the passive structural components, such as the said central body and closure rings. Thus, these can be mechanised or moulded using conventional plastics, thermoplastics or thermally stable materials, and by complying simply with some basic requirements of chemical and dimensional stability. Thus, it is possible to use materials such as polyolefins (polyethylene or polypropylene), halogenated plastics such as polyvinyl chloride, polytetrafluoroethylene or others, specialised plastics such as polyamides, aliphatic polyesters, polycarbonate, polyacetals or others, high-performance or engineering polymer materials such as polyetherketones, polyamideimides, polysulphones, polyimides, polyetherimides, aromatic polyesters, aromatic polyoxides, thermally stable polymers such as polybenzimidazole or polyquinoxalines, rigid crystal polymers or other similar materials, as well as their mixture or alloys. The cross-linked thermally stable materials can include phenolic resins, polyesters, epoxy resins or others, preferably with reinforcements such as glass fibre or other similar compounds. Alternatively, these structural components can be made of specialised ceramic materials.

As previously stated, the current collectors must have a perforated central area which is permeable to gases and vapours. For optimum configuration of the system, this permeable area should not extend to the entire collector, but only to the area which is in physical contact with the attached electrode. Thus, it is advantageous, but not intrinsically essential, for the perimeter area on which the threaded ring is supported to be without perforations, in order to assure the sealing of the system, particularly in the case of the anodic collector.

Alternatively, instead of a perforated metal plate, it is possible to use other elements as an electrical collector, provided that they comply with the basic requirements of mechanical rigidity (in order to avoid buckling with loss of electrical contact between the collector and the MEA (Membrane Electrode Assembly)), adequate permeability and adequate chemical stability, for the purpose of maintaining a high level of electrical conductivity. Thus, for example, it is possible to use metal mesh, rigid open-cell metal foams, sheets of rigid polymer material (composite or engineering polymers) or ceramic with electrical conductivity on the surface (by surface metallisation) or in the mass (by filling with carbon blacks, metal particles, or polymers which conduct electricity).

In view of the intrinsic characteristics of the fuel cells, which give rise to useful cell voltages which in general are too low to be used directly in practical applications (in the case of the hydrogen fuel cells generally less than 1 V, and in the direct methanol fuel cells generally less than 0.7 V), it is advantageous to have a determined number of unit cells connected in series. Thus, the current collectors must have a means for permitting electrical interconnection of some unit cells with others (either in series or in parallel, according to the particular circumstances). In the preferred option, this interconnection can take place by means of a lateral flat flange or tab (which provides the collector with a shape of the “racquet” type), which, via electrical connections outside the body of the actual fuel cell, makes it possible to establish the appropriate contacts. These flanges can be accommodated in a recess provided in the female thread of the central body. An alternative option is direct connection of an electric cable in the centre of a circular collector, by means of techniques such as spot, arc, electrical welding or the like. This option has the difficulty that the connection cable of each anodic collector will occupy part of the anodic compartment, and must pass through the central body in order to be able to emerge to the exterior of the mini-fuel cell itself, where the appropriate connections will be made.

In the case of functioning using hydrogen as a fuel, for a typical nominal operating voltage of 0.6 V, an elemental module of the type described, with two elemental fuel cell connected in series, would provide an operating voltage of 1.2 V. These values continue to be relatively low for most practical applications, such that in general it is desirable to connect more than two unit cells in series in order to access higher voltages.

### DRAWINGS AND REFERENCES

To complement the description, and for the purpose of assisting better understanding of the characteristics of the invention, according to a preferred embodiment of the invention, as an integral part of this description a set of drawings with an illustrative and non-limiting nature is provided.

FIG. 1 shows a schematic representation of an elemental two-cell mini fuel cell module seen from one of its faces.

FIG. 2 shows a schematic representation of an elemental two-cell mini fuel cell module seen in lateral view.

FIG. 3 shows a schematic representation of a current collector.

FIG. 4 shows a schematic representation of the exploded view of the elemental two-cell fuel cell module.

FIG. 5 shows schematically some of the existing possibilities for combining two-cell modules in order to configure mini fuel cells with 4 individual cells (FIG. 5A), 6 individual cells (FIG. 5B and FIG. 5C) or 10 individual cells (FIG. 5D).

FIG. 6 shows a polarisation curve obtained experimentally with a two-cell module similar to that schematised in FIG. 1, using in this case hydrogen as the fuel and oxygen as the oxidant air.

In these figures, the references are as follows:
1. Body
2. Closure ring
3. Cathodic electrical connector
4. Anodic electrical connector
5. Seal
6. MEA (Membrane Electrode Assembly)
7. Additional sealing
8. Fuel connection port
9. Recess
10. Recess
11. Permeable central part
12. Non-permeable perimeter area
13. Electrical connection tab
13a. Electrical connection tab for the cathodic collector of the cell 1.
13b. Electrical connection tab for the anodic collector of the cell 1.
13c. Electrical connection tab for the cathodic collector of the cell 2.
13d. Electrical connection tab for the anodic collector of the cell 2.

### DESCRIPTION OF A PREFERRED EMBODIMENT

The elemental module, the drawing of which is shown schematically in FIG. 1, consists of two individual cells, one on view from its front surface, and the other, in the rear part, which is symmetrical with respect to the former, and cannot be seen from the viewpoint of the reader, “Elemental cell” refers to the set formed by an MEA (Membrane Electrode Assembly), its anodic collector and its cathodic collector. The said elemental module thus consists of a central body 1 onto which both individual cells are secured. In this case, the octagonal shape of the said central body has a purely illustrative value, for the purpose of facilitating the interpretation of the drawings, and the body can have any other geometric shape according to the particular needs of each case. The following description relates to the individual cell which is on view, on the understanding that at the rear part, which is not on view, there is another similar individual cell.

Each individual cell is secured to the body 1 by means of a closure ring 2, which is screwed onto the body 1, This closure ring leaves exposed to the air the corresponding cathodic collector 3, which consists of a series of pores, apertures, perforations or holes (represented schematically in FIG. 1 by means of a grid), thus permitting passage of the oxygen from the air to the cathode of the corresponding individual cell. The flanges 13a, 13b, 13c and 13d represent the tabs of the electrical collectors, by means of which the electrical connections of the mini-fuel cell can be formed, such that the tab 13a corresponds to the cathodic collector of the front individual cell, and 13b corresponds to the anodic collector. With respect to the individual cell of the rear part, the tab 13c corresponds to its cathodic collector, and 13d corresponds to the anodic collector. Thus, if it is wished to connect in series both individual cells of the two-cell module represented, it is possible for example to connect the tab 13b to 13c, leaving 13a and 13d as positive and negative poles respectively.

There exist other alternatives to the use of tabs such as those described for the electrical connection between the electrical connectors, the tabs described being one of the possible options which exist for descriptive purposes. The same figure shows by means of two projections 8 two connection ports for the fuel, such that one of them acts as an input and the other acts as an output, in the latter case in order to permit an external connection with other mini fuel cell modules, with an automatic venting valve, or for other purposes. Similarly, it is possible to dispense with one of the said connection ports 8, if it is wished to have only an input port, without an output.

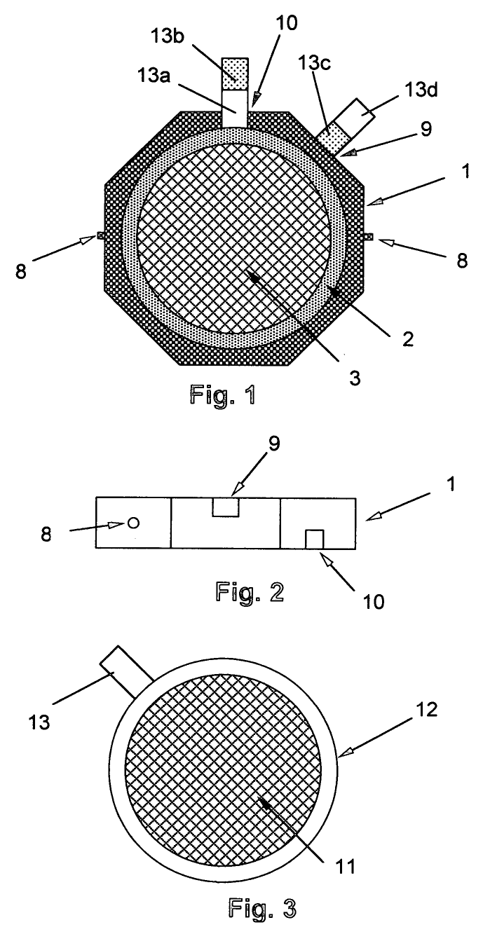

FIG. 2 represents a lateral view at 45° from the elevation of the central body in FIG. 1. It shows a fuel connection port 8, as well as both recesses 9 and 10, which serve the purpose of accommodating the tabs 13a and 13b on one side, and 13c and 13d on the other side, respectively. FIG. 3 represents an electrical collector (3 or 4) in which there can be seen a permeable central part 11 which coincides with the electrode surface of the cell, a dense perimeter area 12 which is non-permeable, i.e. which has no perforations or holes, for the purpose of avoiding detracting from the sealing of the assembly, and an electrical connection tab 13.

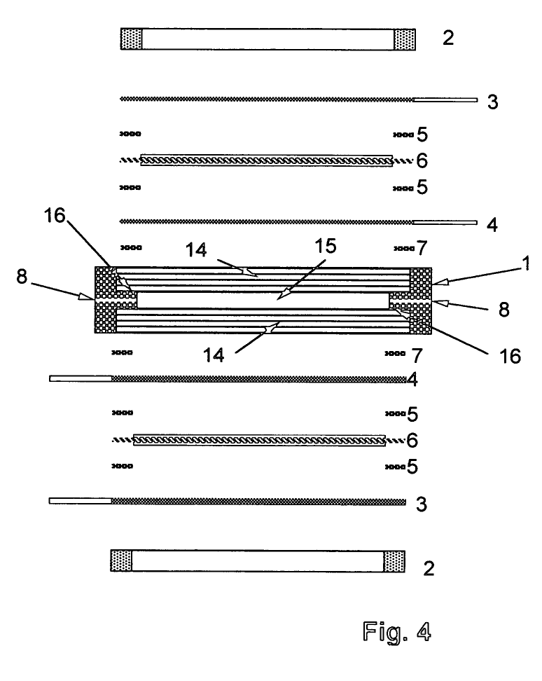

FIG. 4 represents the cross-section of the exploded view of a two-cell elemental module such as that described in FIG. 1. It shows the symmetrical arrangement of each of the elemental cells, one on the upper part of the drawing, and the other on the lower part. Thus, one of the rings 2 secures in position by means of screwing the following elements which constitute each of the elemental cells: a cathodic collector 3, an anodic collector 4, two seals 5, and an MEA (Membrane Electrode Assembly) 6. In addition, there can be an extra sealing element 7 between the anodic collector 4 and the body 1. The assembly of the collectors/seals/MEA (Membrane Electrode Assembly) is secured in position by means of the ring 2 by being screwed onto the body 1; this screw is represented by the thread 14. This assembly is supported on an annular projection 16, leaving an anodic space 15. This anodic space can remain empty, or optionally it can accommodate functional elements, such as: turbulence promoters (especially for the case of dissolved liquid fuels), elements for absorption of humidity (especially for the case of gaseous fuels such as hydrogen, in order to retain excess condensation, and in turn release this humidity during the periods of non-functioning, thus avoiding premature drying out of the electrolytic membranes), or others. The perforations 8 represent the input channels, and, if it is considered appropriate, the output channels for the fuel which is not used.

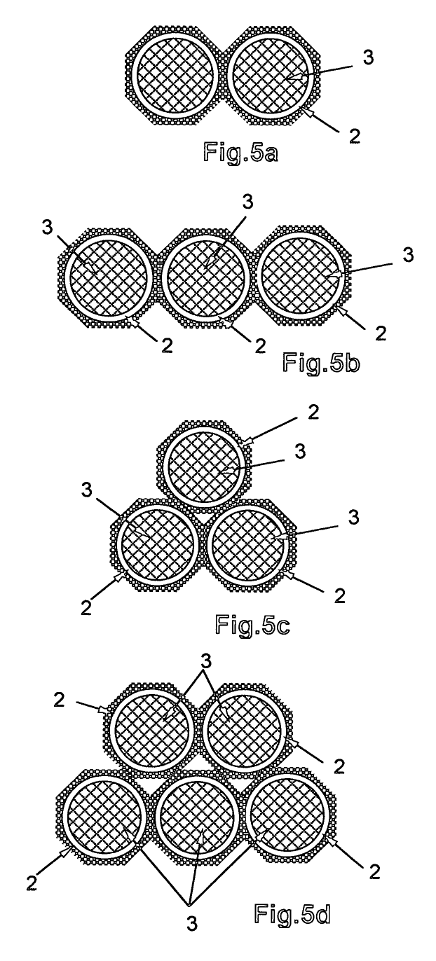

Everything described in the aforementioned figures corresponds to the simplest possible arrangement of the technology of mini fuel cells which is the subject of this invention, with only two individual cells. In practice, it may generally be desirable to have mini fuel cells with more than two elements connected in series, for the purpose of obtaining higher voltages. FIG. 5 (A, B, C and D) shows schematically, for illustrative and non-restrictive purposes, some of the arrangements which can be conceived, in which there are combined various two-cell modules such as the one described. Thus, FIG. 5A represents a quadruple mini fuel cell (with four individual cells in total, with two on each side), FIGS. 5B and 5C show a sextuple mini fuel cell in two different configurations, and finally FIG. 5D represents a configuration of ten cells.

It should be noted that the combination of these two-cell modules does not necessarily have to be by means of discrete modules such as that shown in FIG. 1, but the drawings in FIG. 5 or other similar figures can be monolithic, with a common central body which accommodates a series of anodic compartments, which in turn are delimited by two elemental cells, one at each side of the body, as shown in FIG. 4. The drawings in A to D can have one or more fuel input and/or output points, and in general there exist various options for internal distribution of the fuel through internal channels or apertures provided in the central body, in the manner of the apertures 8 in FIG. 4. The drawings A to D which are shown in the figures leave open the possibility of placing two or more multi-cell modules such as these in parallel with one another, in order to increase further still the nominal voltage and obtain devices with greater power.

### EXAMPLE 1

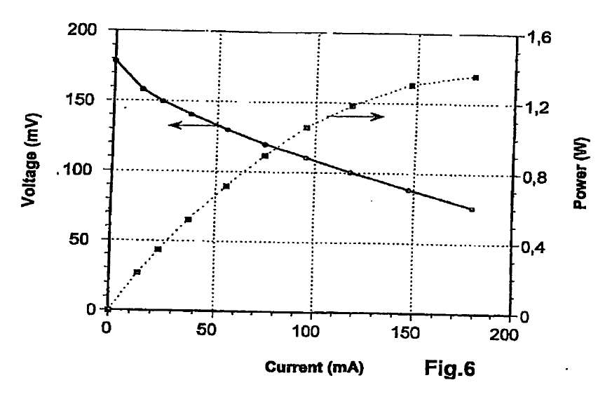

In order to demonstrate the concept, a two-cell mini fuel cell was prepared (i.e. with two elemental cells), with an active electrode area of 5 cm². This mini fuel cell consisted of an MEA (Membrane Electrode Assembly) suitable for functioning with hydrogen as the fuel and air as the oxidant, in passive conditions, i.e. without auxiliary elements for heating, cooling, humidification or forced impelling of the reagents, with the hydrogen accessing the anodic compartment by means of a small excess pressure regulated by a valve provided for this purpose in the storage device of the compartment (outside the actual mini fuel cell), and air for natural convection. FIG. 6 shows a characteristic polarisation curve for this system, which, as can be seen, provides power of 1.1 W to 1.1 V, with a current of 1 A, the maximum power in practice being 1.4 W.

### EXAMPLE 2

The design of the two-cell module described has the advantage that it can easily be extrapolated to modules with a larger number of cells, in general of an even number, by means of the appended lateral arrangement of different two-cell modules. This arrangement can be established by means of discrete elemental two-cell modules, such that the output for the fuel not used in each module is connected to the input of the next, and with the appropriate electrical connections. However, in compact areas of the system it is far more convenient to have all these two-cell modules in a monolithic common central body, with as many anodic compartments as there are two-cell modules, connected to one another by a passage channel in order to permit correct distribution of the fuel. Thus, it is relatively simple to design and construct modules with two (as already described), four, six, eight or more unit cells, giving rise to typical total nominal voltages, if all the cells are connected in series, of 1.2 V, 2,4 V, 3.6 V and 4.8 V respectively.

The electrical current generated will depend on various parameters (nature and content of electro-catalysts in the electrodes, nature and state of the electrolytic membranes, operating voltage, etc), but especially of the active area of the electrode. For the purpose of illustration, taking into consideration some typical performance levels of 150 mA/cm² at 0.6 V for a passive mini fuel cell supplied with dry hydrogen, and an active electrode area of 7 cm² (circular with diameter of 3 cm), the following nominal performance levels are obtained for modules with between 2 and 8 unit cells:

| No. of | Nominal voltage | Nominal current | |
|---|---|---|---|
| cells per | (relating to 0.6 | (for 7 cm² of | Approximate |
| module | V per cell) | active area) | nominal power |
| 2 | 1.2 V | 1050 mA | 1.3 W |
| 4 | 2.4 V | 1050 mA | 2.5 W |
| 6 | 3.6 V | 1050 mA | 3.8 W |
| 8 | 4.8 V | 1050 mA | 5.0 W |

The combination in a common system of several of these modules connected electrically in series, and with a fuel supply which is preferably in parallel in order to avoid excessive accumulation of water in the final anodic compartments of the series, will lead to total power levels and voltages which are multiple the number of modules such as those described connected. Thus, for example, the combination in a common system of four modules with eight individual cells as described will lead to a generator for a nominal 20 W and 19.2 V. The purpose of this guideline data is to illustrate the versatility and flexibility of the main design, which in the case described makes it possible to obtain power levels in the range between approximately 1 and 30 W,

1. Mini fuel cell with a screw-type closure system, characterised in that it has two sets of electrodes/electrolytic membranes/electrodes (MEA (Membrane Electrode Assembly)) situated respectively at both sides of a central body, delimiting an anodic space in the centre, and the said MEAs(Membrane Electrode Assembly) together with their corresponding electrical collectors being secured in position by means of two rings, which, by means of a screwing procedure, ensure that the assembly is completely hermetic,

2. Mini fuel cell with a screw-type closure system according to claim 1, characterised in that, in order to obtain some specific MEAs (Membrane Electrode Assemblies), it functions as a fuel cell supplied by (pure or reformed) hydrogen and air.

3. Mini fuel cell with a screw-type closure system according to claim 1, characterised in that, in order to obtain some specific MEAs (Membrane Electrode Assemblies), it functions as a methanol/air battery, wherein the methanol is in aqueous solution.

4. Mini fuel cell with a screw-type closure system according to claim 1, characterised in that, in order to obtain some specific MEAs (Membrane Electrode Assemblies), it functions with other oxygenated liquid fuels such as alcohols (ethanol, 1- and 2-propanol, ethylene glycol, glycerin or the like) and other compounds with higher levels of oxidation such as ethers (dimethyl ether, dimethoxymethane or trimethoxymethane), aldehydes (formaldehyde, glyoxal) or acids (formic acid, acetic acid), inter alia.

5. Mini fuel cell with a screw-type closure system according to claim 1, characterised in that, in order to obtain some specific MEAs (Membrane Electrode Assemblies), it functions with other, non-oxygenated fuels such as chemical hydrides of the sodium tetrahydroborate type (NaBH₄) in an alkaline solution.

6. Mini fuel cell with a screw-type closure system according to claim 1, characterised in that it is designed to be structured with an even number of cells and more than two, i.e. between four and twenty, constructed by flat lateral juxtaposition of a certain number of two-cell modules, such as that described in claim 1, in interconnected discrete modules, or as a monolith with a common central body, and which can function with fuels such as those described.

7. Mini fuel cell with a screw-type closure system according to claim 1, characterised in that it is designed to be structured by means of the superimposition in parallel of a certain number of, and in general between 2 and 100, multi-cell modules such as those described in claim 6, with sufficient separation between them to permit access by air to the cathodes of the individual cells (by spontaneous diffusion or with an attached ventilation element), to configure a generator with a higher power level.

8. Mini fuel cell with a screw-type closure system according to claim 1, characterised in that it is designed to be structured also with unit cells on only a single side of the anodic compartment.
